(19) United States
(12) Patent Application Publication
(10) Pub. No.: US 2017/0140730 A1
(43) Pub. Date: May 18, 2017

(54) Multi-voltage Generator and Liquid Crystal Display

(71) Applicant: Shenzhen China Star Optoelectronics Technology Co. Ltd., Shenzhen, Guangdong (CN)

(72) Inventors: Xianming ZHANG, Shenzhen, Guangdong (CN); Dan CAO, Shenzhen, Guangdong (CN)

(73) Assignee: Shenzhen China Star Optoelectronics Technology Co., Ltd., Shenzhen, Guangdong (CN)

(21) Appl. No.: 14/891,754

(22) PCT Filed: Apr. 30, 2015
(86) PCT No.: PCT/CN2015/078003

§ 371 Date: Nov. 17, 2015

(30) Foreign Application Priority Data
Apr. 14, 2015 (CN) 201510176254.3

(51) Int. Cl. G09G 3/36

(52) U.S. Cl. CPC G09G 3/3696; G09G 2310/0289; G09G 2310/08

(57) ABSTRACT

The present invention proposes a multi-voltage generator and an LCD. The multi-voltage generator includes a controller, a control interface, and a selector. The controller outputs a control signal to the control interface in accordance with displaying frames of the liquid crystal display and one of display modes, and the control interface outputs a voltage level signal to the selector based on the control signal. The selector outputs a voltage signal mapping an output voltage signal value in response to the voltage level signal. In this way, the multi-voltage generator outputs adaptive voltage signal according to displaying frames of the liquid crystal display and the display mode, so that the liquid crystal display can upgrade display quality and show vivid images.

### BACKGROUND OF THE INVENTION

1. Field of the Invention

The present invention relates to the field of liquid crystal display, and more particularly, to a multi-voltage generator and liquid crystal display.

2. Description of the Prior Art

In a liquid crystal display (LCD), thin film transistors (TFTs) are turned on/off in turn during scanning period. Data voltage from a source driver is applied on a pixel electrode when the TFT turns on. Alignment of liquid crystals is determined according to a voltage difference between the pixel electrode and a common electrode so as to show various grey levels. Therefore, the turn-on/turn-off voltage and common voltage applied on the common electrode should be controlled.

A conventional LCD are driven by two groups of Gamma voltages and a group of common voltage VCOM.

Display quality for various display modes is required, only one group common voltages VCOM is not enough for different display modes. Specifically, the conventional LCD adjusts common voltage VCOM in accordance with the flicker frame with 0-255 grey level in a 2-dimension (2D) mode, which is insufficient for showing image under a 3-dimension (3D) mode.

### SUMMARY OF THE INVENTION

The present invention proposes a multi-voltage generator and a liquid crystal display, which is capable of outputting adaptive common voltage according to displaying frames of the liquid crystal display and the display mode, so that the liquid crystal display can upgrade display quality and show vivid images under various display frames and display modes.

According to the present invention, a multi-voltage generator applied in a liquid crystal display comprises a controller, a control interface, and a selector connected in sequence. The controller outputs a control signal to the control interface in accordance with displaying frames of the liquid crystal display and one of display modes, and the control interface outputs a voltage level signal to the selector based on the control signal. The selector outputs a voltage signal mapping an output voltage signal value in response to the voltage level signal. The controller is a timing controller. The control interface is a single interface.

Furthermore, the selector comprises a memory for storing a plurality of voltage signals mapping various voltage level signals. The selector is also used for selecting the voltage signal value stored in the memory based on the voltage level signals and for outputting voltage signal based on the voltage signal values.

Furthermore, the selector is a programmable graphical processing integrated circuit (P-Gamma IC).

According to the present invention, a multi-voltage generator applied in a liquid crystal display comprises a controller, a control interface, and a selector connected in sequence. The controller outputs a control signal to the control interface in accordance with displaying frames of the liquid crystal display and one of display modes, and the control interface outputs a voltage level signal to the selector based on the control signal. The selector outputs a voltage signal mapping an output voltage signal value in response to the voltage level signal.

Furthermore, the selector comprises a memory for storing a plurality of voltage signals mapping various voltage level signals. The selector is also used for selecting the voltage signal value stored in the memory based on the voltage level signals and for outputting voltage signal based on the voltage signal values.

Furthermore, the selector is a programmable graphical processing integrated circuit (P-Gamma IC).

Furthermore, the controller is a timing controller.

Furthermore, the control interface is a single interface.

According to the present invention, a liquid crystal display comprises a controller, a control interface, and a selector connected in sequence. The controller outputs a control signal to the control interface in accordance with displaying frames of the liquid crystal display and one of display modes, and the control interface outputs a voltage level signal to the selector based on the control signal. The selector outputs a voltage signal mapping an output voltage signal value in response to the voltage level signal.

Furthermore, the selector comprises a memory for storing a plurality of voltage signals mapping various voltage level signals. The selector is also used for selecting the voltage signal value stored in the memory based on the voltage level signals and for outputting voltage signal based on the voltage signal values.

Furthermore, the selector is a programmable graphical processing integrated circuit (P-Gamma IC).

Furthermore, the controller is a timing controller.

Furthermore, the control interface is a single interface.

In contrast to prior art, the controller outputs a control signal to the control interface in accordance with displaying frames of the liquid crystal display and one of display modes. The control interface outputs a voltage level signal to the selector based on the control signal. In response to the voltage level signal, the selector outputs a voltage signal mapping an output voltage signal value. In this way, the multi-voltage generator outputs adaptive voltage signal according to displaying frames of the liquid crystal display and the display mode, so that the liquid crystal display can upgrade display quality and show vivid images.

### BRIEF DESCRIPTION OF THE DRAWINGS

FIG. 1 shows a schematic diagram of a multi-voltage generator according to a first preferred embodiment of the present invention.

FIG. 2 shows a schematic diagram of a multi-voltage generator according to a second preferred embodiment of the present invention.

FIG. 3 illustrates a relationship between the voltage signals and the voltage level signals according to the second preferred embodiment of the present invention.

FIG. 4 illustrates a schematic diagram of a liquid crystal display (LCD) according to a preferred embodiment of the present invention.

### DETAILED DESCRIPTION OF THE PREFERRED EMBODIMENTS

Referring to FIG. 1 showing a schematic diagram of a multi-voltage generator according to a first preferred embodiment of the present invention, the multi-voltage generator comprises a controller 101, a control interface 102, and a selector 103 connected in sequence.

The controller 101 outputs a control signal to the control interface 102 in accordance with displaying frames of the liquid crystal display and one of display modes. The control interface 102 outputs a voltage level signal to the selector 103 based on the control signal. In response to the voltage level signal, the selector 103 outputs a voltage signal mapping an output voltage signal value.

The controller 101, coupled to a graphical processing integrated circuit, is used for acquiring the content and display mode of the displaying frames. The content of the displaying frame includes a night scene, a day scene, and other scenes with specific color. The display mode includes 2-dimension mode, 3-dimension mode, and other display modes. The controller 101 is used for converting the graphical signal into control signal and transmitting it to the control interface 102.

The control interface 102 converts the control signal into voltage level signal, or transmits voltage level signal mapping the control signal to the selector 103.

The selector 103 outputs voltage signal in response to the voltage level signal. The voltage signal is applied to a common electrode of the display panel.

Please note, a relationship among the control signal, the voltage level signal and the voltage signal is one to one.

In contrast to prior art, the controller outputs a control signal to the control interface in accordance with displaying frames of the liquid crystal display and one of display modes. The control interface outputs a voltage level signal to the selector based on the control signal. In response to the voltage level signal, the selector outputs a voltage signal mapping an output voltage signal value. In this way, the multi-voltage generator outputs adaptive voltage signal according to displaying frames of the liquid crystal display and the display mode, so that the liquid crystal display can upgrade display quality and show vivid images.

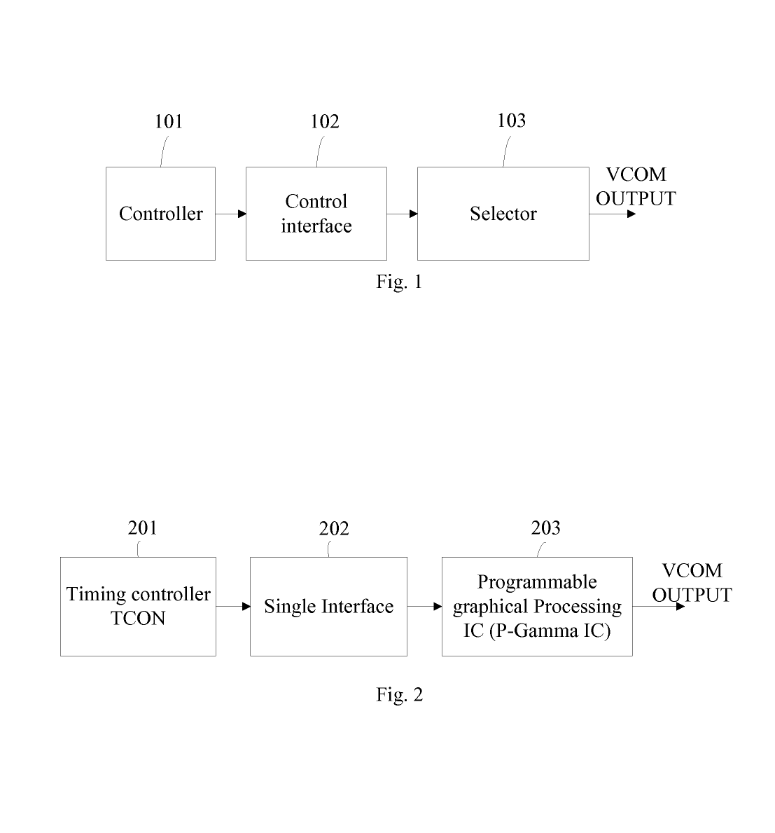

Refer to FIG. 2 showing a schematic diagram of a multi-voltage generator according to a second preferred embodiment of the present invention.

The multi-voltage generator comprises a timing controller (TCON) 201, a single interface 202, and a programmable graphical processing integrated circuit (e.g. a P-Gamma IC) 203 connected in sequence.

The timing controller 201 outputs a control signal to the single interface 202 in accordance with displaying frames of the liquid crystal display and one of display modes. The single interface 202 outputs a voltage level signal to the programmable graphical processing integrated circuit 203 based on the control signal. In response to the voltage level signal, the programmable graphical processing integrated circuit 203 outputs a voltage signal mapping an output voltage signal value.

The programmable graphical processing integrated circuit 203 comprises a memory (not shown) which stores a plurality of voltage signal values mapping various voltage level signals. The programmable graphical processing integrated circuit 203 further outputs voltage signal based on a voltage signal value selected from the plurality of voltage signal values stored in the memory.

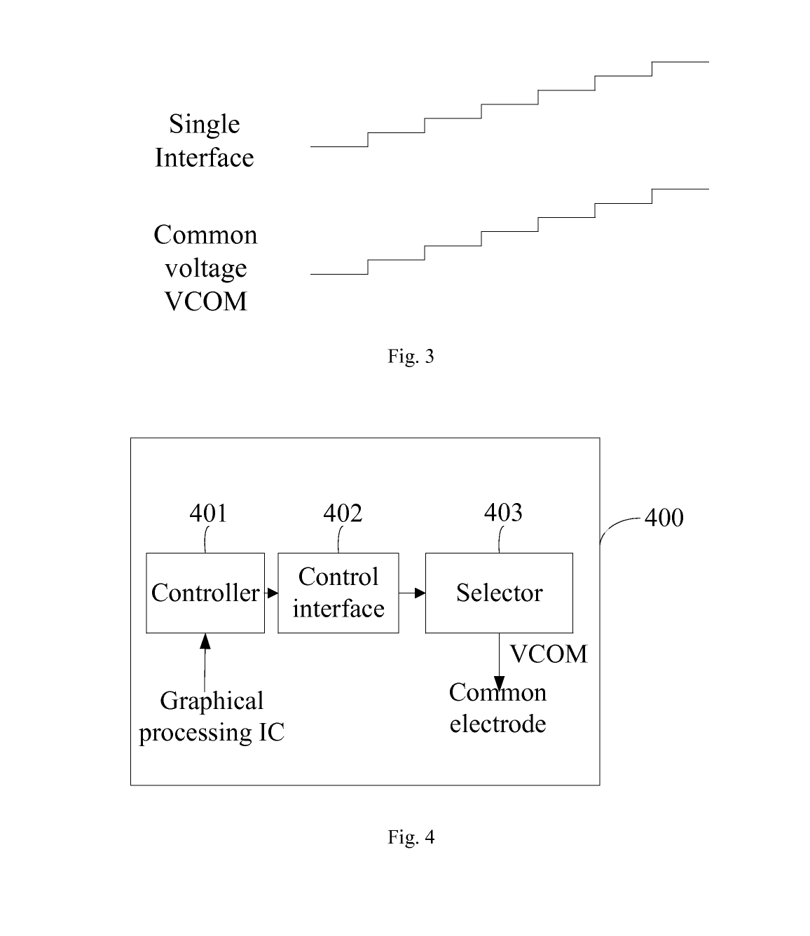

Refer to FIG. 3 illustrating a relationship between the voltage signals and the voltage level signals according to the second preferred embodiment of the present invention.

As shown in FIG. 3, the programmable graphical processing integrated circuit 203 determines a range of the common voltage VCOM, and divides the common voltage VCOM into a plurality of voltage signal values. The plurality of voltage signal values are stored in a memory. The single interface 202 divides a plurality of voltage level signals according to the plurality of voltage signal values divided from the common voltages VCOM. Each voltage level signal corresponds to one of the voltage signals. In response to the voltage level signal from the single interface 202, a selector of the programmable graphical processing integrated circuit (P-Gamma IC) 203 selects a voltage signal mapping an output voltage signal value stored in the memory, and outputs the voltage signal to the common electrode.

This embodiment introduces the specific elements which are operated in the same way as the first embodiment.

Referring to FIG. 4 illustrating a schematic diagram of a liquid crystal display (LCD) 400 according to a preferred embodiment of the present invention, the LCD 400 comprises a controller 401, a control interface 402 and a selector 403 connected in sequence. The controller 401 outputs a control signal to the control interface 402 in accordance with displaying frames of the liquid crystal display and one of display modes. The control interface 402 outputs a voltage level signal to the selector 403 based on the control signal. In response to the voltage level signal, the selector 403 outputs a voltage signal mapping an output voltage signal value as a common voltage.

The selector 403 comprises a memory (not shown in Figure) which stores a plurality of voltage signal values corresponding to voltage level signals. The selector 403 is also used for outputting voltage signal based on the voltage signal values stored in the memory.

In addition, the memory can be another external memory connected to the selector 403, which is installed in the LCD.

Preferably, the selector 403 can be a programmable graphical processing integrated circuit (P-Gamma IC).

Preferably, the controller 401 is a timing controller TCON.

Preferably, the control interface 402 is a single interface.

In this embodiment, the multi-voltage generator applied in the LCD is used for supplying various common voltages to the common electrode. The programmable graphical processing integrated circuit P-Gamma IC, timing controller TCON, and single interface can be inherent elements in the LCD 400, or other added elements.

In contrast to prior art, the controller outputs a control signal to the control interface in accordance with displaying frames of the liquid crystal display and one of display modes. The control interface outputs a voltage level signal to the selector based on the control signal. In response to the voltage level signal, the selector outputs a voltage signal mapping an output voltage signal value. In this way, the multi-voltage generator outputs adaptive voltage signal according to displaying frames of the liquid crystal display and the display mode, so that the liquid crystal display can upgrade display quality and show vivid images.

Although the present invention has been explained by the embodiments shown in the drawings described above, it should be understood to the ordinary skilled person in the art that the invention is not limited to the embodiments, but rather various changes or modifications thereof are possible without departing from the spirit of the invention. Accordingly, the scope of the invention shall be determined only by the appended claims and their equivalents.

What is claimed is:

1. A multi-voltage generator applied in a liquid crystal display, comprising a controller, a control interface, and a selector connected in sequence;
wherein the controller outputs a control signal to the control interface in accordance with displaying frames of the liquid crystal display and one of display modes, and the control interface outputs a voltage level signal to the selector based on the control signal;
the selector outputs a voltage signal mapping an output voltage signal value in response to the voltage level signal;
the controller is a timing controller; and
the control interface is a single interface.

2. The multi-voltage generator of claim 1, wherein the selector comprises a memory for storing a plurality of voltage signals mapping various voltage level signals;
the selector is also used for selecting the voltage signal value stored in the memory based on the voltage level signals and for outputting voltage signal based on the voltage signal values.

3. The multi-voltage generator of claim 2, wherein the selector is a programmable graphical processing integrated circuit (P-Gamma IC).

4. A multi-voltage generator applied in a liquid crystal display, comprising a controller, a control interface, and a selector connected in sequence;
wherein the controller outputs a control signal to the control interface in accordance with displaying frames of the liquid crystal display and one of display modes, and the control interface outputs a voltage level signal to the selector based on the control signal;
the selector outputs a voltage signal mapping an output voltage signal value in response to the voltage level signal.

5. The multi-voltage generator of claim 4, wherein the selector comprises a memory for storing a plurality of voltage signals mapping various voltage level signals;
the selector is also used for selecting the voltage signal value stored in the memory based on the voltage level signals and for outputting voltage signal based on the voltage signal values.

6. The multi-voltage generator of claim 5, wherein the selector is a programmable graphical processing integrated circuit (P-Gamma IC).

7. The multi-voltage generator of claim 4, wherein the controller is a timing controller.

8. The multi-voltage generator of claim 4, wherein the control interface is a single interface.

9. A liquid crystal display comprising a controller, a control interface, and a selector connected in sequence;
wherein the controller outputs a control signal to the control interface in accordance with displaying frames of the liquid crystal display and one of display modes, and the control interface outputs a voltage level signal to the selector based on the control signal;
the selector outputs a voltage signal mapping an output voltage signal value in response to the voltage level signal.

10. The liquid crystal display of claim 9, wherein the selector comprises a memory for storing a plurality of voltage signals mapping various voltage level signals;
the selector is also used for selecting the voltage signal value stored in the memory based on the voltage level signals and for outputting voltage signal based on the voltage signal values.

11. The liquid crystal display of claim 10, wherein the selector is a programmable graphical processing integrated circuit (P-Gamma IC).

12. The liquid crystal display of claim 9, wherein the controller is a timing controller.

13. The liquid crystal display of claim 9, wherein the control interface is a single interface.
